(19) United States
(12) Patent Application Publication
(10) Pub. No.: US 2022/0007572 A1
(43) Pub. Date: Jan. 13, 2022

(54) SWITCHABLE CUTTING BLADE PAIRED WITH HARVESTER BLADE PROTECTOR

(71) Applicant: KONGMENG YE, Dongguan, Guangdong (CN)

(72) Inventor: KONGMENG YE, Dongguan, Guangdong (CN)

(21) Appl. No.: 17/292,426

(22) PCT Filed: Aug. 21, 2018
(86) PCT No.: PCT/CN2018/101607

§ 371 Date: May 7, 2021

(30) Foreign Application Priority Data
Aug. 8, 2018 (CN) 201810893050.5

(51) Int. Cl. A01D 34/13

(52) U.S. Cl. CPC A01D 34/13

(57) ABSTRACT

The present invention provides a switchable cutting blade paired with a harvester knife guard. The switchable cutting blade comprises a switchable cutting blade assembly in which a knife guard is not included and which is provided with notches, so that waste blockage can be cleaned automatically. The switchable cutting blade assembly comprises a cutting bucket steel plate and a plurality of cutting blade bottom frames which is arranged on the cutting bucket steel plate and is closely connected. Each cutting blade bottom frame comprises a triangular part A and a groove frame which is integrated with the triangular part A. Each of the groove frames and the corresponding cutting blade bottom frame form an ┘ shape; each two adjacent cutting blade bottom frames are fixed by a crossbar to form a new knife guard. Each cutting blade bottom frame is provided with a cutting blade component. Each cutting blade component comprises a blade part and a mounting part arranged at the rear end of the blade part. Each mounting part comprises a groove which is fixed on the corresponding groove frame. The switchable cutting blade disclosed by the present invention has the main advantages that a mounting face C and the corresponding cutting blade bottom frame can be fixed at the cutting bucket steel plate together by screws. A new knife guard can also be directly welded on the cutting bucket steel plate.

### TECHNICAL FIELD

The present invention relates to a cutting blade technology for a harvester, more particularly to a switchable cutting blade paired with a harvester knife guard.

### BACKGROUND ART

A harvesting knife guard for a harvester may have a single claw, double claws, three claws or other shapes, and their task is to function as cutting pieces to harvest vegetation and the like. The harvesting knife guard has the operation principle that the cutting blade is in balancing contact with the surface of the knife guard, and the cutting blade moves left and right by a rocker arm to complete the cutting task.

After a period of friction between the cutting blade and a surface part of the knife guard during the operation, the cutting blade and the knife guard are subject to wear, and to a certain degree of wear will affect the cutting task. In this way, it is necessary to replace with a new cutting blade and a new knife guard. Only one piece of cutting blade needs to be replaced, but the knife guard is an entire casting. The entire set of casting must be discarded and replaced with a new knife guard just owing to a certain degree of wear on the surface, which not only wastes a lot of resources, but also takes time to perform the replacement assembly work.

### SUMMARY OF THE INVENTION

For this purpose, a main object of the present invention is to provide a switchable cutting blade paired with a harvester knife guard.

The technical solution adopted in the present invention is as follows:

the present invention provides a switchable cutting blade paired with a harvester knife guard, comprising:

a switchable cutting blade assembly in which a knife guard is not included and which is provided with notches, so that waste blockage can be cleaned automatically.

The switchable cutting blade assembly comprises a cutting bucket steel plate and a plurality of cutting blade bottom frames which is arranged on the cutting bucket steel plate and is closely connected; each cutting blade bottom frame comprises a triangular part A and a groove frame which is integrated with the triangular part A; each of the groove frames and the corresponding cutting blade bottom frame form an shape; each two adjacent cutting blade bottom frames are fixed by a crossbar; each cutting blade bottom frame is provided with a cutting blade component; each cutting blade component comprises a blade part and a mounting part arranged at the rear end of the blade part; each mounting part comprises a groove which is fixed on the corresponding groove frame.

Further, each mounting part comprises a mounting face C and through holes formed in the mounting face C; the through holes are fixed with the cutting bucket steel plate by screws or bolts, and a plurality of notches which is uniformly arranged is formed in one end of the mounting face C close to the grooves.

Further, each trough groove and the corresponding cutting bucket steel plate are fixed by screws or by welding.

Further, each blade part is of a V-shaped structure which consists of two triangular cutting blades.

Further, inclined teeth are arranged on the side surface of each triangular cutting blade and form the blade part.

Further, protection plates are arranged on both sides of the cutting bucket steel plate respectively.

Further, each mounting face C and the corresponding blade part are located on the same horizontal surface.

Further, each crossbar is fixed by welding in a manner of attaching a connecting face between the corresponding groove frame and the corresponding triangular part A, or is formed by integral casting.

Further, a gap is formed in the middle of each groove.

Further, each notch is provided with an opening facing one end of the groove.

The switchable cutting blade disclosed by the present invention has the main advantages that the mounting face C and the new knife guard can be directly fixed at the cutting bucket steel plate together by screws.

### BRIEF DESCRIPTION OF THE DRAWINGS

FIG. 1 and FIG. 5 are partially structural schematic diagrams of the present invention;

FIG. 2 is a structural schematic diagram of the present invention;

FIG. 3 is a structural schematic diagram of a cutting blade component in the present invention;

FIG. 4 is a structural schematic diagram after a cutting blade is assembled in the present invention; and

FIG. 6 is a structural schematic diagram of an alternative structure of a mounting part provided in the present invention.

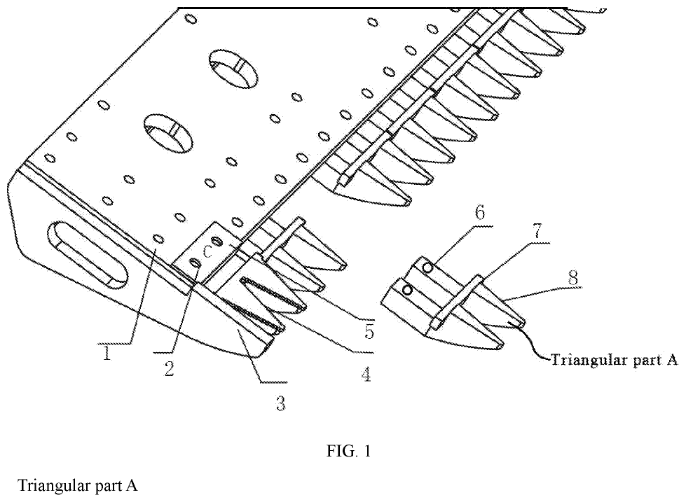

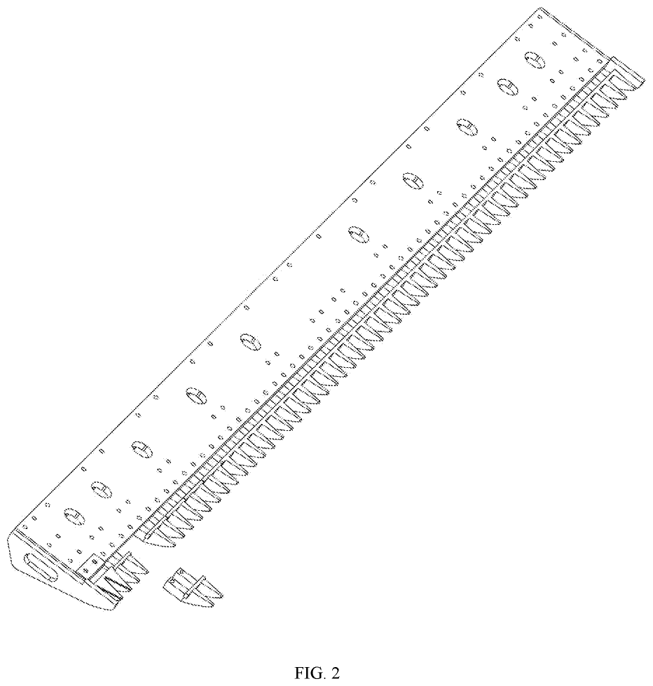

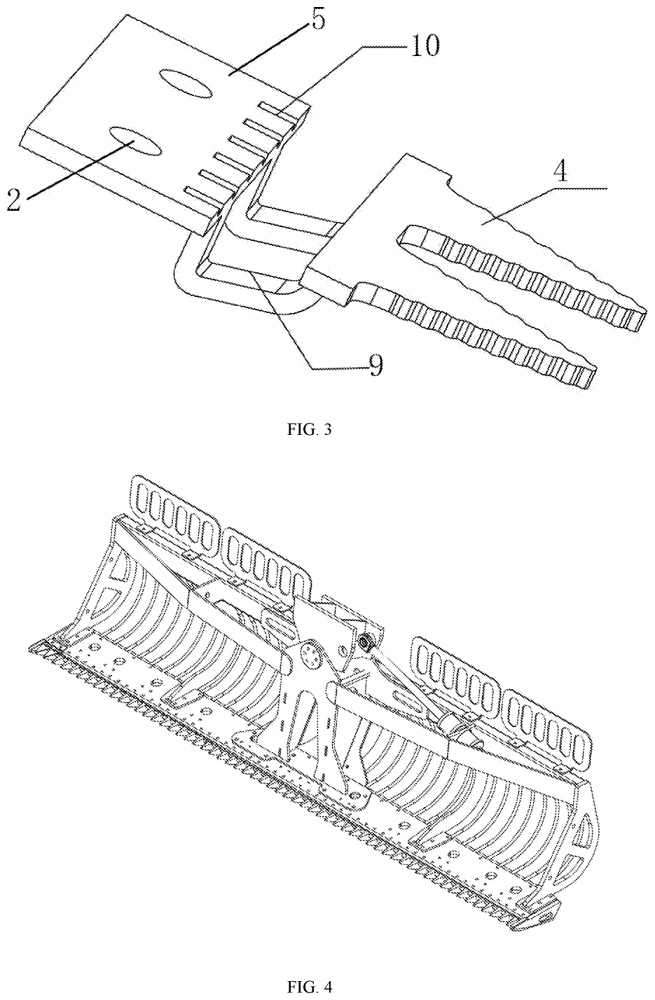

### DETAILED DESCRIPTION

The present invention will be described in detail below with reference to the accompanying drawings and specific embodiments. Here, the exemplary embodiments and descriptions of the present invention are used to explain the present invention, but are not intended to limit the present invention.

The present invention provides a switchable cutting blade paired with a harvester knife guard. The switchable cutting blade comprises a switchable cutting blade assembly in which a knife guard is not included and which is provided with notches, so that waste blockage can be cleaned automatically.

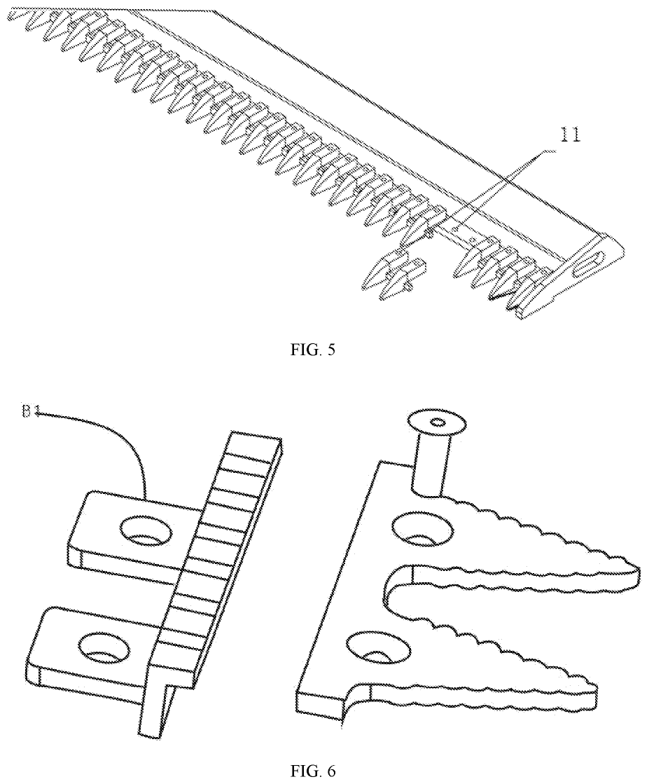

The switchable cutting blade assembly comprises a cutting bucket steel plate 1 and a plurality of cutting blade bottom frames which is arranged on the cutting bucket steel plate and is closely connected. Each cutting blade bottom frame comprises a triangular part A 8 and a groove frame 6 which is integrated with the triangular part A 8. The groove frames 6 and the cutting bucket steel plate 1 are fixed by welding, or referring to FIG. 5, fixed by screws via tapping holes 11. Each groove frame 6 and the corresponding cutting blade bottom frame 1 form an ┘ shape. Each two adjacent cutting blade bottom frames are fixed by a crossbar 7. The crossbar 7 is fixed by welding in a manner of attaching a connecting face between the groove frame 6 and the triangular part A 8. In the present invention, the fixing manner between the cutting bottom frames and the groove frames 6 is not limited to the above-mentioned form, and the groove frames and the cutting blade bottom frames may also be formed by integral casting, both of which fall within the protection scope of the present invention. Each cutting blade bottom frame is provided with a cutting blade component. Each cutting blade component comprises a blade part 4. Each blade part is of a V-shaped structure which consists of two triangular cutting blades. Inclined teeth are arranged on the side surface of each triangular cutting blade and form the blade part. A mounting part is provided at the rear end of the blade part 4, wherein the mounting part comprises a groove 9 which is fixed on the corresponding groove frame 6. Each mounting part comprises a mounting face C 5 and through holes 2 formed in the mounting face C 5. The through holes 2 are fixed together with the cutting bucket steel plate 1 and the cutting blade bottom frames by screws or bolts, and a plurality of notches 10 which is uniformly arranged is formed in one end of the mounting face C 5 close to the grooves 9. Each mounting face C 5 and the corresponding blade part 4 are located on the same horizontal surface. Protection plates 2 are arranged on both sides of the cutting bucket steel plate 1 respectively.

The present invention has the main advantages: each mounting face C and the corresponding cutting blade bottom frame may be directly fixed to the cutting bucket steel plate by screws, and the cutting blade bottom frame is welded to the steel plate, such that the cutting blade bottom frame serves as a knife guard, and there is no need to assemble or disassemble a knife guard for a brand-new cutting bucket. If a blade protector needs to be installed when the cutting blade bottom frames are fixed on the steel plate without welding, the knife guard can also be directly installed with screws.

Meanwhile, according to the present invention, the notches 10 are provided at the mounting face 5, a gap is formed in the middle of each groove 9, and each notch 7 is provided with an opening facing one end of the groove. Conventionally, some slits will appear during the contact between all the knife guard and the blades, and will cause accumulation of debris. When the accumulation reaches a certain level, the blade should be removed and cleaned, otherwise it will affect the cutting task. Now, since the notches 10 are formed on the surface of the mounting face C, those debris will be torn and fall into the notches 10 without causing blockage.

In addition, in the present invention, the mounting parts can be replaced with two parts as shown in FIG. 6. The notches are formed in a surface B 1. Owing to the notches on the surface Bl, the debris will be torn and fall into the notches without causing blockage.

The technical solution disclosed by the embodiments of the present disclosure has been described in detail above. Specific embodiments are used herein to explain the principles and implementations of the present invention. The descriptions of the above embodiments are only configured to help understand the principle of the embodiments of the present invention. Meanwhile, for a person of ordinary skill in the art, there will be changes in the specific implementation and the application scope according to the embodiments of the present disclosure. In summary, the content of the Description should not be understood as a limitation on the present invention.

1. A switchable cutting blade paired with a harvester knife guard, comprising:
a switchable cutting blade assembly in which a knife guard is not included and which is provided with notches, so that waste blockage can be cleaned automatically.

2. The switchable cutting blade assembly comprises a cutting bucket steel plate and a plurality of cutting blade bottom frames which is arranged on the cutting bucket steel plate and is closely connected; each cutting blade bottom frame comprises a triangular part A and a groove frame which is integrated with the triangular part A; each of the groove frames and the corresponding cutting blade bottom frame form an [symbol] shape; each two adjacent cutting blade bottom frames are fixed by a crossbar; each cutting blade bottom frame is provided with a cutting blade component; each cutting blade component comprises a blade part and a mounting part arranged at the rear end of the blade part; each mounting part comprises a groove which is fixed on the corresponding groove frame.

3. The switchable cutting blade paired with the harvester knife guard according to claim 1, wherein each mounting part comprises a mounting face C and through holes formed in the mounting face C; the through holes are fixed with the cutting bucket steel plate by screws or bolts, and a plurality of notches which is uniformly arranged is formed in one end of the mounting face C close to the grooves.

4. The switchable cutting blade paired with the harvester knife guard according to claim 1, wherein each trough groove and the cutting bucket steel plate are fixed by screws or by welding.

5. The switchable cutting blade paired with the harvester knife guard according to claim 1, wherein each blade part is of a V-shaped structure which consists of two triangular cutting blades.

6. The switchable cutting blade paired with the harvester knife guard according to claim 4, wherein inclined teeth are arranged on the side surface of each triangular cutting blade and form the blade part.

7. The switchable cutting blade paired with the harvester knife guard according to claim 1, wherein protection plates are arranged on both sides of the cutting bucket steel plate respectively.

8. The switchable cutting blade paired with the harvester knife guard according to claim 1, wherein each mounting face C and the corresponding blade part are located on the same horizontal surface.

9. The switchable cutting blade paired with the harvester knife guard according to claim 1, wherein each crossbar is fixed by welding in a manner of attaching a connecting face between the corresponding groove frame and the corresponding triangular part A, or is formed by integral casting.

10. The switchable cutting blade paired with the harvester knife guard according to claim 1, wherein a gap is formed in the middle of each groove.

11. The switchable cutting blade paired with the harvester knife guard according to claim 2, wherein each notch is provided with an opening facing one end of the groove.
